(19) United States
(12) Patent Application Publication
(10) Pub. No.: US 2022/0227155 A1
(43) Pub. Date: Jul. 21, 2022

(54) THERMAL TRANSFER SHEET

(71) Applicant: Dai Nippon Printing Co., Ltd., Tokyo (JP)

(72) Inventor: Yoshihiro IMAKURA, Tokyo (JP)

(73) Assignee: Dai Nippon Printing Co., Ltd., Tokyo (JP)

(21) Appl. No.: 17/151,250

(22) Filed: Jan. 18, 2021

(51) Int. Cl. B41M 5/392; B41M 5/50

(52) U.S. Cl. CPC B41M 5/392; B41M 5/502

(57) ABSTRACT

Provided is a thermal transfer sheet that can be used for producing not a simple print but a print having a novel function.

A thermal transfer sheet includes a substrate, a dye layer provided on one surface of the substrate and including a dye, and a dye fading accelerating layer provided on the one surface of the substrate frame-sequentially to the dye layer and including a dye fading accelerating material that accelerates fading of the dye.

### BACKGROUND OF THE INVENTION

### Field of the Invention

The present invention relates to a thermal transfer sheet.

### Description of the Related Art

For production of prints, an image forming method in which a thermal transfer sheet having a dye layer is used to transfer an image onto a transfer receiving article such as a card or thermal transfer image-receiving sheet by a sublimation-type thermal transfer method has been widely used. In an image forming method using a sublimation-type thermal transfer method, energy is applied to a thermal transfer sheet, a dye (sublimable dye) contained in a dye layer is caused to migrate to the side of a transfer receiving article, and thus, an image can be formed on the transfer receiving article (e.g., see Patent Literature

### CITATION LIST

### Patent Literature

Patent Literature 1 Japanese Patent Laid-Open No. 2016-193546

### SUMMARY OF THE INVENTION

### Technical Problem

The present invention aims principally to provide a thermal transfer sheet that can be used for producing not a simple print but a print having a novel function.

### Solution to Problem

A thermal transfer sheet of the present invention to solve the problem is characterized by including a substrate, a dye layer provided on one surface of the substrate and including a dye, and a dye fading accelerating layer provided on the one surface of the substrate frame-sequentially to the dye layer and including a dye fading accelerating material that accelerates fading of the dye.

In the thermal transfer sheet, the dye fading accelerating material is preferably one or both of an acid-based material and a fluorescent brightening agent.

### Advantageous Effects of Invention

According to the thermal transfer sheet of the present invention, it is possible to form a desired image with a dye layer as well as to form a dye fading accelerating image including a dye fading accelerating material on the lower side or the upper side of the image formed with the dye layer. Then, it is possible to accelerate fading of the dye in the image with the elapse of time due to the influence of the dye fading accelerating material in the dye fading accelerating image, and finally, it is possible to erase the image (color) on the portion in contact with the dye fading accelerating image. In other words, according to the thermal transfer sheet of the present disclosure, it is possible to produce a print in which a portion of the formed image disappears with the elapse of time.

### BRIEF DESCRIPTION OF THE DRAWINGS

FIG. 1 is a schematic sectional view of a thermal transfer sheet according to the present embodiment;

FIG. 2A is a schematic sectional view of a print produced using the thermal transfer sheet shown in FIG. 1 immediately after production;

FIG. 2B is a schematic front view of the print;

FIG. 3A is a schematic sectional view of a print produced using the thermal transfer sheet shown in FIG. 1, one month after production;

FIG. 3B is a schematic front view of the print;

FIG. 4A is a front view of a print produced using the thermal transfer sheet according to the present embodiment immediately after production;

FIG. 4B is a front view of the print after a predetermined time has elapsed;

FIG. 5A is a schematic sectional view of a print producing using the thermal transfer sheet according to the present embodiment;

FIG. 5B is a schematic sectional view of a print producing using the thermal transfer sheet according to the present embodiment;

FIG. 5C is a schematic sectional view of a print producing using the thermal transfer sheet according to the present embodiment; and

FIG. 5D is a schematic sectional view of a print producing using the thermal transfer sheet according to the present embodiment.

### DETAILED DESCRIPTION OF THE PREFERRED EMBODIMENTS

### (1) Thermal Transfer Sheet

Hereinafter, a thermal transfer sheet according to the embodiment of the present invention will be specifically described with reference to the drawings. The present invention may be embodied in many different aspects and should not be construed as being limited to the description of the exemplary embodiments below. In the drawings, components may be shown schematically regarding the thickness, shape and the like of each layer, compared with actual aspects, for the sake of clearer illustration. The schematic drawings are merely examples and do not limit the interpretations of the present invention in any way. In the specification and the drawings, components that have substantially the same functions as those described before with reference to a previous drawing(s) bear the identical reference signs thereto, and detailed descriptions thereof may be omitted.

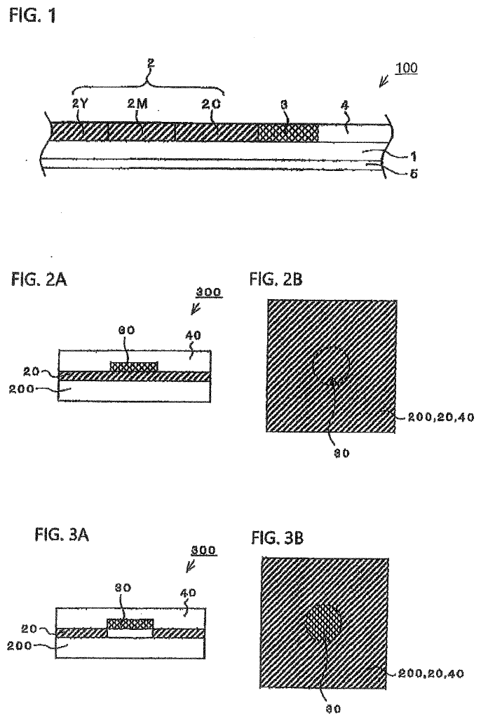

FIG. 1 is a schematic sectional view of a thermal transfer sheet according to the present embodiment.

As shown in FIG. 1, a thermal transfer sheet 100 according to the present embodiment includes a substrate 1, a dye layer 2 provided on one surface, that is, the upper surface in FIG. 1, of the substrate 1, the dye layer 2 including a dye, and a dye fading accelerating layer 3 provided frame-sequentially with this dye layer 2, the dye fading accelerating layer 3 including a dye fading accelerating material that accelerates fading of the dye, as essential constituents. The thermal transfer sheet 100 according to the present embodiment is not required to be composed only of the substrate 1, the dye layer 2, and the dye fading accelerating layer 3. As shown in FIG. 1, a transfer layer 4 for transferring a so-called protective layer may be provided frame-sequentially with the dye layer 2 and the dye fading accelerating layer 3, and a back face layer 5 may be provided on the other surface, that is, the lower surface in FIG. 1, of the substrate 1.

### (2) Action and Effect (Mechanism) of Thermal Transfer Sheet

Before the layers constituting the thermal transfer sheet 100 according to the present embodiment shown in FIG. 1 are described in detail, the action and effect of this thermal transfer sheet 100 will be described first with reference to the drawings.

FIG. 2A is a schematic sectional view of a print produced using the thermal transfer sheet shown in FIG. 1 immediately after production, and FIG. 2B is a schematic front view of the print.

For example, when a print 300 is produced using a transfer receiving article 200, represented by a thermal transfer image-receiving sheet or a substrate for various cards, and the thermal transfer sheet 100 according to the present embodiment shown in FIG. 1, the cross section of the print 300 is constituted by a so-called generic image 20 formed by transferring the dye layer 2, a dye fading accelerating image 30 formed by transferring a dye fading accelerating layer 3 on a predetermined portion on this generic image 20 (the center portion in FIG. 2), and a transfer layer (protective layer) 40 formed by transferring the transfer layer 4 on a portion covering entirely the generic image 20 and the dye fading accelerating image 30, as shown in FIG. 2A.

FIG. 3A is a schematic sectional view of a print produced using the thermal transfer sheet shown in FIG. 1, one month after production, and FIG. 3B is a schematic front view of the print.

For example, the print 300 shown in FIG. 2 is left in an indoor environment. In this case, in the cross section of this print 300, as shown in FIG. 3A, the color of the generic image 20 at the portion in contact with the dye fading accelerating image 30 has come off due to a dye fading accelerating material contained in the dye fading accelerating image 30, and the color of the portion has disappeared. Accordingly, when the print 300 is viewed from the front, the color of the generic image 20 at the portion in which the dye fading accelerating image 30 is formed has disappeared, as shown in FIG. 3B, and thus, a new white pattern appears on the portion.

As mentioned above, producing the print 300 using the thermal transfer sheet 100 according to the present embodiment enables formation of the dye fading accelerating image 30 including the dye fading accelerating material by use of the dye fading accelerating layer 3, allowing the color of the generic image 20 in contact with the dye fading accelerating image 30 to fade (disappear) with the elapse of time. In other words, according to the thermal transfer sheet 100 of the present embodiment, it is possible to produce a print in which a portion of the formed generic image 20 disappears with the elapse of time.

### (3) Layers Constituting Thermal Transfer Sheet

Hereinbelow, each of the layers constituting the thermal transfer sheet 100 according to the present embodiment, which provides the action and effect, will be described specifically.

### (3-1) Substrate

The substrate 1 supports the dye layer 2 and the dye fading accelerating layer 3 located on one surface of the substrate 1, and further, the back face layer 5 located on the other surface of the substrate 1. There is no particular limitation on the material of the substrate 1, and materials having heat resistance and mechanical characteristics are preferred. Specific examples thereof include various plastic films or sheets of: polyesters such as polyethylene terephthalate and polyethylene naphthalate, polyarylate, polycarbonate, urethane resins, polyimides, polyetherimides, cellulose derivatives, polyethylene, ethylene-vinyl acetate copolymers, polypropylene, polystyrene, acrylic resins, polyvinyl chloride, polyvinylidene chloride, polyvinyl alcohol, polyvinyl butyral, nylon, polyether ether ketone, polysulfone, polyethersulfone, tetrafluoroethylene perfluoroalkyl vinyl ether copolymers, polyvinyl fluoride, tetrafluoroethylene-ethylene copolymers, tetrafluoroethylene-hexafluoropropylene copolymers, polychlorotrifluoroethylene, and polyvinylidene fluoride. There is also no particular limitation on the thickness of substrate 1, and the thickness thereof is preferably 0.5 μm or more and 50 μm or less, more preferably 1 μm or more and 20 μm or less, even more preferably 1 μm or more and 10 μm or less.

### (3-2) Dye Layer

As shown in FIG. 1, in the thermal transfer sheet 100 according to the present embodiment, the dye layer 2 is provided on one surface of the substrate 1. The dye layer 2 may be provided in direct contact with the substrate 1 as shown in FIG. 1 or may be provided indirectly via another layer such as various primer layers (not shown), for example. The dye layer 2 may be a combination of a plurality of dye layers each having a different color, that is, a yellow dye layer 2Y, a magenta dye layer 2M, and a cyan dye layer 2C, as shown in FIG. 1, or may be a single dye layer (not shown).

The dye layer 2 like this contains a sublimable dye and a binder.

There is no particular limitation on the sublimable dye, and the sublimable dye may be appropriately selected from sublimable dyes known in the art and used. Specific examples thereof can include diarylmethane-type dyes, triarylmethane-type dyes, thiazole-type dyes, merocyanine dyes, pyrazolone dyes, methine-type dyes, indoaniline-type dyes, pyrazolomethine type-dyes, azomethine-type dyes such as acetophenoneazomethine, pyrazoloazomethine, imidazoleazomethine, imidazoazomethine, and pyridoneazomethine, xanthene-type dyes, oxazine-type dyes, cyanostyrene-type dyes such as dicyanostyrene and tricyanostyrene, thiazine-type dyes, azine-type dyes, acridine-type dyes, benzeneazo-type dyes, azo-type dyes such as pyridoneazo, thiopheneazo, isothiazoleazo, pyrroleazo, pyrrazoleazo, imidazoleazo, thiadiazoleazo, triazoleazo, and disazo, spiropyran-type dyes, indolinospiropyran-type dyes, fluoran-type dyes, rhodaminelactam-type dyes, naphthoquinone-type dyes, anthraquinone-type dyes, and quinophthalone-type dyes. More specific examples thereof can include red dyes such as MS Red G (Mitsui Toatsu Kagaku Kabushiki Kaisha), Macrolex Red Violet R (Bayer AG), Ceres Red 7B (Bayer AG), and Samaron Red F3BS (Mitsubishi Chemical Corporation), yellow dyes such as Foron Brilliant Yellow 6GL (Clariant GmbH), PTY-52 (Mitsubishi Chemical Corporation), and Macrolex yellow 6G (Bayer AG), and blue dyes such as Kayaset® Blue 714 (NIPPON KAYAKU Co., Ltd.), Foron Brilliant Blue S-R (Clariant GmbH), MS Blue 100 (Mitsui Toatsu Kagaku Kabushiki Kaisha), and C.I. Solvent Blue 63.

There is no particular limitation on the binder, and a binder may be appropriately selected from conventionally known sublimable dyes and used. Specific examples thereof can include cellulosic resins such as ethyl cellulose resins, hydroxyethyl cellulose resins, ethyl hydroxy cellulose resins, methyl cellulose resins, and cellulose acetate resins, vinyl resins such as polyvinyl alcohol, polyvinyl acetate, polyvinyl butyral, polyvinyl acetoacetal, and polyvinyl pyrrolidone, acrylic resins such as poly(meth)acrylate and poly(meth)acrylamide, urethane resins, polyamides, and polyesters. Among these, cellulosic resins, vinyl resins, acrylic resins, urethane resins, polyesters, and the like are preferable from the viewpoint of heat resistance, dye migration and the like.

There is no limitation on the content of the sublimable dye and the binder, and the content of the sublimable dye is preferably 50% by mass or more and 350% by mass or less, more preferably 80% by mass or more and 300% by mass or less, based on the total mass of the binder. Setting the content of the sublimable dye and the binder to the content enables an image having a higher density to be formed. The storage stability of the thermal transfer sheet 100 also can be improved.

The dye layer 2 may also contain a release agent. Allowing the dye layer 2 to contain a release agent makes the releasability between a transfer receiving article and dye layer 2 during formation of an image good. Examples of the release agent can include solid waxes such as polyethylene waxes, amide waxes, and Teflon® powder, fluorine, phosphoric acid esters, and silicone-containing compounds. Among these, silicone-containing compounds are preferred. Examples of the silicone-containing compounds include silicone oils and silicone resins.

There is no particular limitation on the thickness of the dye layer 2, and the thickness is preferably 0.3 μm or more and 1.5 μm or less.

There is also no particular limitation on a method for forming the dye layer 2, and the dye layer 2 may be formed by dispersing or dissolving a sublimable dye, a binder, and various additives to be added as required in a suitable solvent to prepare a coating liquid for dye layer, applying this coating liquid on the substrate 1 or an optional layer provided on the substrate 1, and drying the coating liquid.

### (3-3) Dye Fading Accelerating Layer

As shown in FIG. 1, in the thermal transfer sheet 100 according to the present embodiment, the dye fading accelerating layer 3 is provided on the substrate 1, frame-sequentially with the dye layer 2. This dye fading accelerating layer 3 is provided so that the layer 3 can be peeled off from the substrate 1. By application of energy from a thermal head or the like, the entire dye fading accelerating layer migrates to the side of a transfer receiving article, or only a dye fading accelerating material from a binder, mentioned below, migrates to the side of a transfer receiving article.

The dye fading accelerating layer 3 contains a dye fading accelerating material and a binder.

The dye fading accelerating material is only required to have an ability to accelerate fading of the dye in the dye layer 2 and may be appropriately selected in accordance with the dye in the dye layer 2. There is also no particular limitation on the mechanism of fading the dye in the dye layer 2. For example, the dye may be faded by decomposing or breaking a portion of the structure of the chemical substance as the dye.

Examples of the dye fading accelerating material can include acid-based materials and fluorescent brightening agents. Examples of the acid-based material can include phosphoric acid esters, and specific examples thereof can include phosphoric acid ester-type anionic surfactants. Commercially available examples thereof can include PLYSURF® A-208N manufactured by Dai-ichi Kogyo Seiyaku, Co., Ltd. Examples of the fluorescent brightening agent include oxazole-type fluorescent brightening agents, and specific examples thereof include 2,2′-(2,5-thiophenediyl)bis[5-(1,1-dimethylethyl)]benzoxazole. Commercially available examples thereof can include Tinopal OB manufactured by BASF Japan Ltd.

There is no particular limitation on the binder constituting the dye fading accelerating layer 3, and various binders described in “(3-2) Dye layer” can be used.

There is no limitation on the content of the dye fading accelerating material and the binder, and the content of the dye fading accelerating material is preferably 1% by mass or more and 100% by mass or less, more preferably 10% by mass or more and 50% by mass or less, based on the total mass of the binder. Setting the content of the dye fading accelerating material and the binder to the content enables an image having higher dye fading performance to be formed.

The dye fading accelerating layer 3 may also contain a release agent, as the dye layer 2.

There is no particular limitation on the thickness of the dye fading accelerating layer 3, and the thickness is preferably 0.3 μm or more and 1.5 μm or less.

The dye fading accelerating layer 3 may be colored or colorless and transparent or opaque. As described above, the layer 3 may be layered on the generic image 20 formed by a dye layer 2. In such a case, in order not to impair the designability of generic image 20, the layer is preferably colorless and transparent.

There is no particular limitation on a method for forming the dye fading accelerating layer 3, and the layer 3 may be formed by dispersing or dissolving a dye fading accelerating material, a binder, and various additives to be added as required in a suitable solvent to prepare a coating liquid for dye fading accelerating layer, applying this coating liquid on the substrate 1 or an optional layer provided on the substrate 1, and drying the coating liquid.

### (3-4) Transfer Layer

As shown in FIG. 1, in the thermal transfer sheet 100 according to the present embodiment, the transfer layer 4 may be provided frame-sequentially with the dye layer 2 and the dye fading accelerating layer 3. The transfer layer 4 is an optional layer, provided so that the layer 4 can be peeled off from the substrate 1. The layer 4 will migrate to the side of a transfer receiving article via application of energy. According to the thermal transfer sheet 100 of the present embodiment, it is possible to form an image by the dye layer 2 and transfer the transfer layer 4 onto the image with one thermal transfer sheet.

The transfer layer 4 as an example has a layered structure of a peelable layer and a heat seal layer (may be referred to as adhesive layer) which are layered in this order from the side of the substrate 1 (not shown). The transfer layer 4 may have a single-layer structure composed only of a peelable layer or a single-layer structure composed only of a heat seal layer.

The peelable layer as an example contains waxes, a silicone wax, a silicone resin, a silicone-modified resin, a fluorine resin, a fluorine-modified resin, polyvinyl alcohol, an acrylic resin, a thermally cross-linkable epoxy-amino resin, a thermally cross-linkable alkyd-amino resin, and the like. The primer layer may contain one resin singly or may contain two or more resins.

The thickness of the peelable layer is preferably 0.5 μm or more and 5 μm or less.

There is also no limitation on a method for forming the peelable layer, and, for example, the peelable layer may be formed by dissolving or dispersing the components exemplified above in an appropriate solvent to prepare a coating liquid for peelable layer, applying this coating liquid onto the substrate 1, and drying the coating liquid. According to the transfer layer 4 including the peelable layer like this, it is possible to make the durability of a print good by transferring the transfer layer 4.

Components constituting the heat seal layer may be appropriately selected from components having adhesion. Examples of such components can include resin components such as polyesters, ultraviolet absorbing resins, acrylic resins, vinyl chloride-vinyl acetate copolymers, epoxy resins, polycarbonate, acetal resins, polyamides, and polyvinyl chloride.

A heat seal layer in a preferred form contains a polyester. According to a heat seal layer containing a polyester, it is possible to prevent bleeding from occurring in an image formed on a transfer receiving article by transferring the transfer layer 4 including this heat seal layer onto the image formed by the dye layer 2. Specifically, when a print is stored under a high-temperature and high-humidity environment, it is possible to prevent bleeding on the image from occurring. In other words, the heat seal layer in this form has adhesion as well as also serves as a barrier layer that can prevent bleeding on the image from occurring.

Examples of the polyester can include polymers including an ester group obtained by polycondensation of a polyvalent carboxylic acid and a polyhydric alcohol. Examples of the polyvalent carboxylic acid can include terephthalic acid, isophthalic acid, phthalic acid, 2,6-naphthalenedicarboxylic acid, adipic acid, sebacic acid, decanedicarboxylic acid, azelaic acid, dodecadicarboxylic acid, and cyclohexanedicarboxylic acid. Examples of the polyhydric alcohol can include ethylene glycol, propanediol, butanediol, pentanediol, hexanediol, neopentyl glycol, 1,4-cyclohexanedimethanol, decanediol, 2-ethyl-butyl-1-propanediol, and bisphenol A. The polyester may be a copolymer of three or more of polyvalent carboxylic acids and polyhydric alcohols and may be a copolymer with a monomer or polymer such as diethylene glycol, triethylene glycol, and polyethylene glycol. The polyesters also include modified products of the polyesters described above. Examples of the product of the polyesters can include polyester urethanes.

The content of the polyester is preferably 30% by mass or more, more preferably 60% by mass or more, based on the total mass of the heat seal layer. Setting the content of the polyester to the preferred content enables the adhesion with a transfer receiving article and the effect of preventing bleeding of images to be better.

The thickness of the heat seal layer is preferably 0.5 μm or more and 2 μm or less. There is also no limitation on a method for forming the heat seal layer, and the heat seal layer may be formed by dispersing or dissolving the components exemplified above and various additives to be added as required in an appropriate solvent to prepare a coating liquid for heat seal layer, applying this coating liquid onto the substrate 1 or an optional layer provided on the substrate 1, and drying the coating liquid.

An intermediate layer (not shown) may also be provided between the peelable layer and the heat seal layer. There is no limitation on the intermediate layer, and the layer may be appropriately selected from so-called primer layers known in the art and the like.

A release layer (not shown) may also be provided between the substrate 1 and the transfer layer 4. Providing the release layer enables the transferability (may be referred to as peelability ox releasability) of the transfer layer 4 to be good.

### (3-5) Back Face Layer

As shown in FIG. 1, in the thermal transfer sheet 100 according to the present embodiment, the back face layer 5 may be provided on the other surface of the substrate 1. Also the back face layer 5 is an optional layer as the transfer layer 4, and providing the layer 5 enables the thermal resistance, the driving stability of a thermal head on printing, and the like to be improved.

The back face layer 5 may be formed by appropriately selecting resin(s) from the thermoplastic resins known in the art and the like. Examples of the thermoplastic resin can include thermoplastic resins such as polyesters, polyacrylic acid esters, polyvinyl acetate, styrene acrylate, polyurethane, polyolefins such as polyethylene and polypropylene, polystyrene, polyvinyl chloride, polyethers, polyamides, polyimides, polyamideimides, polycarbonate, polyacrylamide, polyvinyl chloride, and polyvinyl acetals such as polyvinyl butyral and polyvinyl acetoacetal, and silicone modified forms of these thermoplastic resins.

A curing agent may be added to the resin. There is no particular limitation on a polyisocyanate that functions as the curing agent, and the polyisocyanates known in the art can be used. Among these, an adduct form of an aromatic isocyanate is desirably used. Examples of the aromatic isocyanate include 2,4-toluene diisocyanate, 2,6-toluene diisocyanate, or a mixture of 2,4-toluene diisocyanate and 2,6-toluene diisocyanate, 1,5-naphthalene diisocyanate, tolidine diisocyanate, p-phenylene diisocyanate, trans-cyclohexane-1,4-diisocyanate, xylylene diisocyanate, triphenylmethane triisocyanate, and tris(isocyanatephenyl)thiophosphate. Particularly, 2,4-toluene diisocyanate, 2,6-toluene diisocyanate, or a mixture of 2,4-toluene diisocyanate and 2,6-toluene diisocyanate is preferred. These polyisocyanates crosslink a hydroxyl group-containing thermoplastic resin by use of its hydroxyl group to thereby improve the coating film strength and heat resistance of the back face layer.

The back face layer 5 preferably contains various additives for improving the slipping property, for instance, a release agent such as a wax, a higher fatty acid amide, a phosphoric ester compound, metal soap, silicone oil, and a surfactant, organic powder such as a fluorine-containing resin, and inorganic particles of s silica, clay, talc, calcium carbonate, or the like, in addition to the thermoplastic resin. The layer 5 particularly preferably contains at least one of the phosphoric ester compound and metal soap.

There is no particular limitation on the thickness of the back face layer 5, and, for example, the thickness is preferably 3 μm or less, more preferably 0.1 μm or more and 2 μm or less.

There is also no particular limitation on a method for forming the back face layer 5, and the back face layer 5 may be formed by dissolving or dispersing the components exemplified above in an appropriate solvent to prepare a coating liquid for back face layer, applying this coating liquid onto the other surface of the substrate 1, and drying the coating liquid.

### (4) Application Examples

Hereinbelow, Application Examples of the thermal transfer sheet according to the present embodiment will be described.

### (4-1) Application Example 1

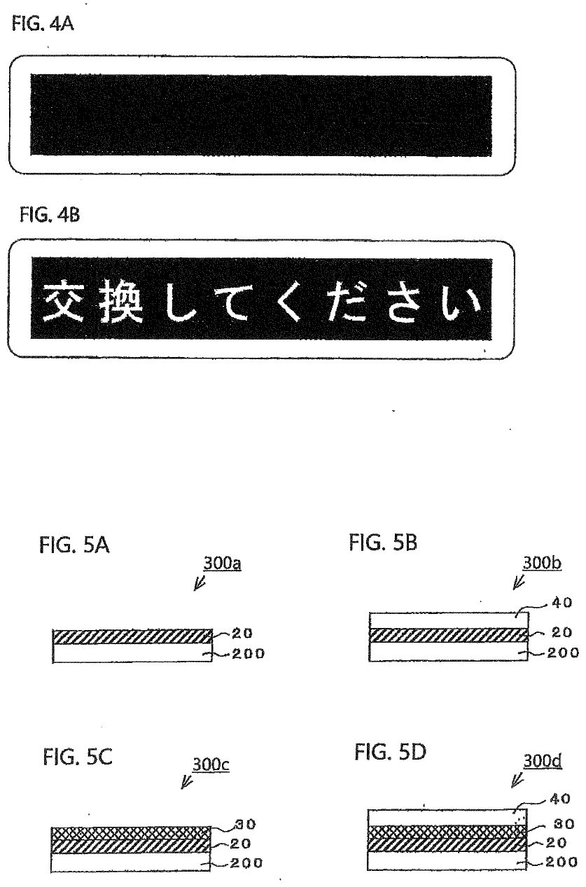

FIG. 4A is a front view of a print produced using the thermal transfer sheet according to the present embodiment immediately after production, and FIG. 4B is a front view thereof after a predetermined time has elapsed.

As shown in FIG. 4B, a message “Please replace” is displayed on the print after a predetermined time has elapsed. As mentioned above, forming a predetermined message using the dye fading accelerating layer in the thermal transfer sheet according to the present embodiment enables the message to be displayed by fading, in other words, color erasure or color missing, after a predetermined time has elapsed. Accordingly, pre-grasping and pre-adjusting the relationship between the dye contained in an image formed using the dye layer and the dye fading accelerating material contained in a dye fading accelerating image formed using the dye fading accelerating layer, more specifically, the relationship between the elapsed time and the degree of fading (fading speed) enables a predetermined message to be displayed after a predetermined time has elapsed. Thus, for example, it is also possible to display the replacement timing for consumables such as batteries or light bulbs.

### (4-2) Application Example 2

It is also possible to appropriately select a dye fading accelerating material to be contained in the dye fading accelerating layer in the thermal transfer sheet according to the present embodiment to thereby accelerate fading of the dye in response to a predetermined external environment. In other words, for example, with attention focused only on the humidity among environment conditions to which the print is exposed, a dye fading accelerating material that accelerates fading of the dye in response to the humidity is selected to thereby enable display of a message in response to the humidity environment to which the print is exposed. Obviously, messages in response to environment conditions other than the humidity, such as temperature, ozone concentration, light, and the like can be displayed.

### (4-3) Application Example 3

FIGS. 5A to 5D are each a schematic sectional view of a print produced using the thermal transfer sheet according to the present embodiment.

For example, when the thermal transfer sheet 100 according to the present embodiment shown in FIG. 1 is used, the following four types of prints each having a layered structure can be produced:

FIG. 5A: a print 300a, in which only a generic image 20 formed by transferring the dye layer 2 is layered on a transfer receiving article 200;

FIG. 5B: a print 300b, in which the generic image 20 formed by transferring the dye layer 2 and a transfer layer 40 formed by transferring the transfer layer 4 are layered in this order on the transfer receiving article 200;

FIG. 5C: a print 300c, in which the generic image 20 formed by transferring the dye layer 2 and a dye fading accelerating image 30 formed by transferring the dye fading accelerating layer 3 are layered in this order on the transfer receiving article 200;

FIG. 5D: a print 300d, in which the generic image 20 formed by transferring the dye layer 2, the dye fading accelerating image 30 formed by transferring the dye fading accelerating layer 3, and the transfer layer 40 formed by transferring the transfer layer 4 are layered in this order on the transfer receiving article 200.

Here, the fading speed of the generic image 20 in the print 300a shown in FIG. 5A is used as the reference, that is, the natural fading speed in the case where the generic image 20 is exposed directly to the external environment, with no dye fading accelerating image 30 and no transfer layer 40, is used as the reference.

In this case, the fading speed of the generic image 20 in the print 300b shown in FIG. 5B becomes lower than the reference because the generic image 20 is protected by the transfer layer 40.

In contrast, the fading speed of the generic image 20 in the print 300c shown in FIG. 5C becomes higher than the reference because the generic image 20 is in contact with the dye fading accelerating image 30.

The fading speed of the generic image 20 in the print 300d shown in FIG. 5D becomes lower than the reference because the generic image 20 is protected by the transfer layer 40, and the fading speed becomes lower than the fading speed of the generic image 20 in print 300b shown in FIG. 5B because of the contact with the dye fading accelerating image 30.

As mentioned above, producing prints different in the layering pattern using the thermal transfer sheet according to the present embodiment enables the fading speed to be varied. This can cause a change in an image a plurality of times with the elapse of time.

In this Application Example 3, when combined with Application Example 2, the fading speed can be finely varied. Further, the fading speed can be varied by a change in the transfer conditions when the generic image or the dye fading accelerating image is transferred or in the material of the transfer layer.

### (5) Transfer Receiving Article

There is no limitation on the transfer receiving article 200 to be combined with the thermal transfer sheet 100 according to the present embodiment and used for producing a print. Transfer receiving articles known in the art to be used for a sublimation-type thermal transfer method, such as a card substrate and a thermal transfer image-receiving sheet, can be appropriately selected and used.

### Example

Next, the thermal transfer sheet according to the embodiment of the present invention will be described concretely with demonstrating Examples. Hereinbelow, unless otherwise particularly specified, the expression of part(s) or % means that by mass. With respect to components except for solvents, a formulation in terms of solid content is represented.

### Example 1

Using a polyethylene terephthalate film having a thickness of 4.5 μm (PET, corona treatment) as a substrate, a coating liquid for primer layer having the following composition was applied on a portion on one surface of this substrate, and the coating liquid was dried to form a primer layer having a thickness of 0.25 μm. Then, a coating liquid for yellow dye layer, a coating liquid for magenta dye layer, and a coating liquid for cyan dye layer having the following composition were applied on the primer layer, and the coating liquids were dried to form a dye layer, in which a yellow dye layer, a magenta dye layer, and a cyan dye layer each having a thickness of 0.5 μm were provided in this order in a frame-sequential manner. On another portion on the surface of the substrate, a coating liquid for peelable layer having the following composition was applied, and the coating liquid was dried to form a peelable layer having a thickness of 1 μm. On a portion on this peelable layer, a coating liquid for dye fading accelerating layer 1 having the following composition was applied, and the coating liquid was dried to form a dye fading accelerating layer having a thickness of 1 μm. On another portion on the peelable layer, a coating liquid for heat seal layer 1 having the following composition was applied, and the coating liquid was dried to form a heat seal layer having a thickness of 1.2 μm. On the other surface of the substrate, a coating liquid for back face layer having the following composition was applied, and the coating liquid was dried to form a back face layer having a thickness of 1 μm. Thus, a thermal transfer sheet of Example 1 was obtained. The peelable layer and the heat seal layer constitute the transfer layer in the thermal transfer sheet of the present disclosure. The concentration of the dye fading accelerating material (phosphoric ester compound) in the dye fading accelerating layer is about 10%.

<Coating liquid for primer layer>

| | | |
|---|---|---|
| Alumina sol | 4 | parts |
| (Alumina sol 200, Nissan Chemical Industries, Ltd.) | | |
| Cationic urethane resin | 6 | parts |
| (SF-600, Dai-ichi Kogyo Seiyaku, Co., Ltd.) | | |
| Water | 100 | parts |
| Isopropyl alcohol | 100 | parts |

<Coating liquid for yellow dye layer>

| | | |
|---|---|---|
| Disperse dye (Foron Brilliant Yellow S-6GL) | 5.5 | parts |
| Polyvinyl acetal | 4.5 | parts |
| (S-LEC(R) KS-5, SEKISUI CHEMICAL CO., LTD.) | | |
| Phosphoric ester type surfactant | 0.1 | part |
| (PLYSURF(R) A208N, Dai-ichi Kogyo Seiyaku, Co., Ltd.) | | |
| Epoxy modified silicone oil | 0.04 | parts |
| (KF-101, Shin-Etsu Chemical Co., Ltd.) | | |
| Polyethylene wax | 0.1 | part |
| Methyl ethyl ketone | 45 | parts |
| Toluene | 45 | parts |

<Coating liquid for magenta dye layer>

| | | |
|---|---|---|
| Disperse dye (MS Red G) | 1.5 | parts |
| Disperse dye (Macrolex Red Violet R) | 2 | parts |
| Polyvinyl acetal | 4.5 | parts |
| (S-LEC(R) KS-5, SEKISUI CHEMICAL CO., LTD.) | | |
| Phosphoric ester type surfactant | 0.1 | part |
| (PLYSURF(R) A208N, Dai-ichi Kogyo Seiyaku, Co., Ltd.) | | |
| Polyethylene wax | 0.1 | part |
| Epoxy modified silicone oil | 0.04 | parts |
| (KF-101, Shin-Etsu Chemical Co., Ltd.) | | |
| Methyl ethyl ketone | 45 | parts |
| Toluene | 45 | parts |

<Coating liquid for cyan dye layer>

| | | |
|---|---|---|
| Disperse dye (Solvent Blue 63) | 3.5 | parts |
| Disperse dye (HSB-2194) | 3 | parts |
| Polyvinyl acetal | 4.5 | parts |
| (S-LEC(R) KS-5, SEKISUI CHEMICAL CO., LTD.) | | |
| Phosphoric ester type surfactant | 0.1 | part |
| (PLYSURF(R) A208N, Dai-ichi Kogyo Seiyaku, Co., Ltd.) | | |
| Polyethylene wax | 0.1 | part |
| Epoxy modified silicone oil | 0.04 | parts |
| (KF-101, Shin-Etsu Chemical Co., Ltd.) | | |
| Methyl ethyl ketone | 45 | parts |
| Toluene | 45 | parts |

<Coating liquid for peelable layer>

| | | |
|---|---|---|
| Acrylic resin | 40 | parts |
| (LP-45M, Soken Chemical & Engineering Co., Ltd.) | | |
| Methyl ethyl ketone | 30 | parts |
| Toluene | 30 | parts |

<Coating liquid for dye fading accelerating layer 1>

| | | |
|---|---|---|
| Polyester | 25 | parts |
| (Vylon(R) 700, TOYOBO CO., LTD.) | | |
| Silicon dioxide | 0.5 | parts |
| (SYLYSIA 310, Fuji Silysia Chemical Ltd.) | | |
| Phosphoric acid ester | 3 | parts |
| (PLYSURF(R) A-208S, Dai-ichi Kogyo Seiyaku, Co., Ltd.) | | |
| Methyl ethyl ketone | 30 | parts |
| Toluene | 30 | parts |

<Coating liquid for heat seal layer>

| | | |
|---|---|---|
| Polyester | 20 | parts |
| (Vylon(R) 700, TOYOBO CO., LTD.) | | |
| Silicon dioxide | 0.5 | parts |
| (SYLYSIA 310, Fuji Silysia Chemical Ltd.) | | |
| Ultraviolet absorbing agent | 5 | parts |
| (ST-IU VA 40KT, Daicel Corporation) | | |
| Methyl ethyl ketone | 30 | parts |
| Toluene | 30 | parts |

<Coating liquid for back face layer>

| | | |
|---|---|---|
| Polyvinyl acetal | 6 | parts |
| (S-LEC(R) BX-1, SEKISUI CHEMICAL CO., LTD.) | | |
| Polyisocyanate curing agent (solid content: 45%) | 22 | parts |
| (BURNOCK(R) D750-45, DIC Corporation) | | |
| Phosphoric acid ester | 5 | parts |
| (PLYSURF(R) A-208N, Dai-ichi Kogyo Seiyaku, Co., Ltd.) | | |
| Methyl ethyl ketone. | 60 | parts |
| Toluene | 60 | parts |

### Example 2

A thermal transfer sheet of Example 2 was obtained exactly in the same manner as in Example 1 except that the coating liquid for dye fading accelerating layer 1 in Example 1 was replaced by a coating liquid for dye fading accelerating layer 2 having the following composition to form the dye fading accelerating layer. The concentration of the dye fading accelerating material (phosphoric ester compound) in the dye fading accelerating layer is about 5%.

<Coating liquid for dye fading accelerating layer 2>

| | | |
|---|---|---|
| Polyester | 25 | parts |
| (Vylon(R) 700, TOYOBO CO., LTD.) | | |
| Silicon dioxide | 0.5 | parts |
| (SYLYSIA 310, Fuji Silysia Chemical Ltd.) | | |
| Phosphoric acid ester | 1.5 | parts |
| (PLYSURF(R) A-208S, Dai-ichi Kogyo Seiyaku, Co., Ltd.) | | |
| Methyl ethyl ketone | 30 | parts |
| Toluene | 30 | parts |

### (Transfer Receiving Article)

As a transfer receiving article for use in combination with the thermal transfer sheets of Example 1 and Example 2, a genuine image receiving sheet for a sublimable type thermal transfer printer (DS-40, Dai Nippon Printing Co., Ltd.) was provided.

### (Production of Prints a to J)

Using the thermal transfer sheets of Example 1 and Example 2 and the transfer receiving article, prints A to J each having a layer configuration shown in Table 1 below were produced by heating with a thermal head, with conditions of output: 0.23 W/dot, line speed: 1.0 msec./line, and dot density: 300 dpi taken as 100%. The transfer condition (heating proportion) on producing each print is as shown in Table 1. A so-called generic image formed by transfer of the dye layer is a black solid (image gray scale (0/255)) image.

### (Evaluation of Fading)

The prints A to J were each placed in the sunshine indoors, and the number of days required to observe fading in the so-called generic image was determined. The presence of fading was visually determined. The results are also shown in Table 1.

TABLE 1

| | Dye fading accelerating layer | | | | | | | |
|---|---|---|---|---|---|---|---|---|
| | | Concentration | | | | | Number of | |
| | | of dye fading | | Transfer layer | | Reference | days until | |
| | Presence/ | accelerating | Transfer | Presence/ | Transfer | FIG. of layer | observation | |
| Print | Absence | material | condition | Absence | condition | configuration | of fading | |
| A | Absence | — | — | Absence | — | FIG. 5A | Half a | |
| | | | | | | | month | |
| B | Presence | 10% | 100% | Absence | — | FIG. 5C | 10 | days |
| C | Absence | — | — | Presence | 100% | FIG. 5B | Half a | |
| | | | | | | | year | |
| D | Presence | 5% | 100% | Presence | 100% | FIG. 5D | 2 | months |
| E | Presence | 10% | 100% | Presence | 100% | FIG. 5D | 1 | month |
| F | Absence | — | — | Presence | 80% | FIG. 5B | 4 | months |
| G | Absence | — | — | Presence | 50% | FIG. 5B | 2 | months |
| H | Absence | — | — | Presence | 120% | FIG. 5B | 9 | months |
| I | Presence | 5% | 80% | Presence | 100% | FIG. 5D | 3 | months |
| J | Presence | 5% | 120% | Presence | 100% | FIG. 5D | 1 | month |

Also as can be seen from Table 1 above, according to the thermal transfer sheets of Examples, prints in which the so-called generic image that changes with the elapse of time were able to be produced, and the timing of the change was able to be controlled.

### REFERENCE SIGNS LIST

100 thermal transfer sheet
1 substrate
2 dye layer
3 dye fading accelerating layer
4 transfer layer
5 back face layer
200 transfer receiving article
20 generic image
30 dye fading accelerating image
40 transfer layer after transfer
300 print

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2018-182612 filed on Sep. 27, 2018 including the specification, claims, drawings and summary is incorporated herein by reference in its entirety.

What is claimed is:

1. A thermal transfer sheet comprising:
a substrate,
a dye layer provided on one surface of the substrate and comprising a dye, and
a dye fading accelerating layer provided on the one surface of the substrate frame-sequentially to the dye layer and comprising a dye fading accelerating material that accelerates fading of the dye.

2. The thermal transfer sheet according to claim 1, wherein the dye fading accelerating material is one or both of an acid-based material and a fluorescent brightening agent.

3. The thermal transfer sheet according to claim 1, wherein the dye fading accelerating material is a phosphoric acid ester.

4. The thermal transfer sheet according to claim 1, wherein the dye fading accelerating material is a phosphoric acid ester-type anionic surfactant.

5. The thermal transfer sheet according to claim 1, wherein the dye fading accelerating material is an oxazole-type fluorescent brightening agent.

6. The thermal transfer sheet according to claim 1, wherein the dye fading accelerating layer is transferred entirely onto a transfer receiving article by application of energy.

7. The thermal transfer sheet according to claim 1, wherein
the dye fading accelerating layer comprises a binder,
the dye fading accelerating material contained in the dye fading accelerating layer is transferred onto a transfer receiving article by application of energy, and
the binder does not migrate to the transfer receiving article.

8. The thermal transfer sheet according to claim 1, wherein
the dye fading accelerating layer comprises a binder, and
the content of the dye fading accelerating material is 1% by mass or more and 100% by mass or less based on the total mass of the binder.

9. The thermal transfer sheet according to claim 1, wherein
the dye fading accelerating layer comprises a binder, and
the content of the dye fading accelerating material is 10% by mass or more and 50% by mass or less based on the total mass of the binder.

10. The thermal transfer sheet according to claim 1, wherein the thickness of the dye fading accelerating layer is 0.3 μm or more and 1.5 μm or less.

11. The thermal transfer sheet according to claim 1, wherein the dye fading accelerating layer is colorless and transparent.

12. The thermal transfer sheet according to claim 1, comprising a transfer layer provided on one surface of the substrate, frame-sequentially to the dye layer and the dye fading accelerating layer.

13. A print comprising:
a generic image comprising a dye, and
a dye fading accelerating image comprising a dye fading accelerating material that accelerates fading of the dye, wherein
the generic image and the dye fading accelerating image are layered in any order on a transfer receiving article.

14. The print according to claim 13, wherein the dye contained in the generic image is faded by the dye fading accelerating material contained in the dye fading accelerating image, and a predetermined message is displayed after a predetermined time has elapsed.

15. The print according to claim 13, wherein fading of the dye contained in the generic image by the dye fading accelerating material contained in the fading accelerating material is accelerated by an external environment to which the print is exposed.

16. The print according to claim 15, wherein the external environment is one or more selected from temperature, humidity, light, and ozone concentration.

17. The print according to claim 13, comprising
a transfer layer in addition to the generic image and the dye fading accelerating image,
two or more layers selected from the generic image, the dye fading accelerating image, and the transfer layer being layered on the transfer receiving article in any order.

18. The print according to claim 17, comprising
a plurality of layering patterns of two or more layers selected from the generic image, the dye fading accelerating image, and the transfer layer,
a fading speed of the dye contained in the generic image differing in accordance with the layering patterns.

19. A method for producing a print comprising:
forming a generic image containing a dye, and
printing a dye fading accelerating image containing a dye fading accelerating material that accelerates fading of the dye.

20. The method for producing a print according to claim 19, further comprising:
transferring a transfer layer, wherein
a portion in which the generic image and the transfer layer are layered, a portion in which the dye fading accelerating image and the transfer layer are layered, and a portion in which the generic image, the dye fading accelerating image, and the transfer layer are layered are each formed.
